(19) United States
(12) Patent Application Publication
(10) Pub. No.: US 2019/0112459 A1
(43) Pub. Date: Apr. 18, 2019

(54) POLYMER BLENDS, FILMS COMPRISING POLYMER BLENDS, AND PACKAGES

(71) Applicant: Dow Global Technologies LLC, Midland, MI (US)

(72) Inventors: Chuan Yar Lai, Houston, TX (US); Arnaldo T. Lorenzo, Freeport, TX (US); Cristina Serrat, Sugar Land, TX (US)

(21) Appl. No.: 16/094,606

(22) PCT Filed: May 4, 2017
(86) PCT No.: PCT/US2017/031038

§ 371 Date: Oct. 18, 2018

Related U.S. Application Data
(60) Provisional application No. 62/332,699, filed on May 6, 2016.

(51) Int. Cl. C08L 23/06; C08J 5/18

(52) U.S. Cl. CPC C08L 23/06; C08J 5/18; C08L 2203/16; C08J 2451/06; C08J 2323/06; C08J 2401/02; C08L 2205/03

(57) ABSTRACT

The present invention relates to polymer blends, to films comprising one or more layers formed from such polymer blends, and to packages. In one aspect, a polymer blend comprises a polyethylene, nanocellulose, wherein the nanocellulose comprises 0.5 to 5 weight percent of the blend based on the total weight of the blend, and maleic anhydride-grafted polyethylene, wherein the maleic anhydride-grafted polyethylene comprises 0.5 to 5 weight percent of the blend based on the total weight of the blend.

### FIELD

The present invention relates to polymer blends, to films comprising one or more layers formed from such polymer blends, and to packages.

### INTRODUCTION

Polyethylene has been used in a number of material and packaging applications for many years. Polymer blends incorporating polyethylene can be used, for example, in films and in packages formed from such films. Polymer manufacturers continue to search for ways to differentiate the polyethylene and blends incorporating polyethylene used in such applications, and film converters and other manufacturers continue to search for improved films and related products. For example, additives have been incorporated into polymer blends to modify or enhance polyethylene properties such as moisture barrier, rigidity, temperature resistance, rheological behavior, and others. However, there remains a need for new polymer blends incorporating polyethylene having desirable properties, and for new films having desirable properties.

### SUMMARY

The present invention provides polymer blends comprising polyethylene that in some aspects provide one or more improved properties. As set forth in more detail herein, such polymer blends incorporate nanocellulose which results in improved properties when compared to polymer blends without nanocellulose. For example, in some aspects, polymer blends of the present invention can have improved melt strengths when compared to polymer blends without nanocellulose. Further, in some aspects, the present invention provides films formed from such polymer blends that can exhibit improved properties such as, for example, barrier properties (e.g., moisture barrier) and mechanical properties (e.g., tensile properties). For example, in some aspects, the inclusion of nanocellulose and maleic anhydride-grafted polyethylene in the polymer blend results in films having improved barrier properties and improved mechanical properties.

In one aspect, the present invention provides a polymer blend that comprises a polyethylene, nanocellulose, wherein the nanocellulose comprises 0.5 to 5 weight percent of the blend based on the total weight of the blend, and maleic anhydride-grafted polyethylene, wherein the maleic anhydride-grafted polyethylene comprises 0.5 to 5 weight percent of the blend based on the total weight of the blend.

In another aspect, the present invention provides a monolayer film comprising any one of the polymer blends of the present invention disclosed herein. In another aspect, the present invention provides a multilayer film, wherein at least one layer comprises any one of the polymer blends of the present invention disclosed herein. In another aspect, the present invention relates to packages formed from any of the films of the present invention disclosed herein.

These and other embodiments are described in more detail in the Detailed Description.

### BRIEF DESCRIPTION OF THE DRAWING

FIG. 1 is a graph illustrating melt strength data measured in connection with the Examples.

### DETAILED DESCRIPTION

Unless stated to the contrary, implicit from the context, or customary in the art, all parts and percents are based on weight, all temperatures are in ° C., and all test methods are current as of the filing date of this disclosure.

The term “composition,” as used herein, refers to a mixture of materials which comprises the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or polymer mixture.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene/α-olefin interpolymer,” as used herein, refers to an interpolymer that comprises, in polymerized form, a majority amount of ethylene monomer (based on the weight of the interpolymer), and an α-olefin.

The term, “ethylene/α-olefin copolymer,” as used herein, refers to a copolymer that comprises, in polymerized form, a majority amount of ethylene monomer (based on the weight of the copolymer), and an α-olefin, as the only two monomer types.

The term “in adhering contact” and like terms mean that one facial surface of one layer and one facial surface of another layer are in touching and binding contact to one another such that one layer cannot be removed from the other layer without damage to the interlayer surfaces (i.e., the in-contact facial surfaces) of both layers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

“Polyethylene” or “ethylene-based polymer” shall mean polymers comprising greater than 50% by weight of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, bis-metallocene catalysts and constrained geometry catalysts, and typically have a molecular weight distribution (“MWD”) greater than 2.5.

The term “HDPE” refers to polyethylenes having densities greater than about 0.935 g/cm³, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cm³, which are generally prepared with Ziegler-Natta catalysts, chrome catalysts, or single-site catalysts including, but not limited to, bis-metallocene catalysts and constrained geometry catalysts.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend.

The term “multilayer structure” refers to any structure comprising two or more layers having different compositions and includes, without limitation, multilayer films, multilayer sheets, laminated films, multilayer rigid containers, multilayer pipes, and multilayer coated substrates.

Unless otherwise indicated herein, the following analytical methods are used in the describing aspects of the present invention:

“Density” is determined in accordance with ASTM D792.

“Melt index”: Melt indices I₂ (or I2) and I₁₀ (or I10) are measured in accordance with ASTM D-1238 at 190° C. and at 2.16 kg and 10 kg load, respectively. Their values are reported in g/10 min.

“Young's Elastic Modulus” is determined in accordance with ASTM D-1708.

“Clarity” is determined in accordance with ASTM D1746.

“Haze” is determined in accordance with ASTM D1003.

“Water Vapor Transmission Rate” or “WVTR” is determined in accordance with ASTM F-1249 using a Mocon Permatran WVTR testing system at a relative humidity of 90% and a temperature of 37.8° C.

“Oxygen Transmission Rate” or “OTR” is determined in accordance with ASTM D3985 using a Mocon Oxtran OTR testing system at an oxygen content of 100%, a relative humidity of 90%, and a temperature of 23° C.

“Carbon Dioxide Transmission Rate” or “CO₂TR” is determined in accordance with ASTM D3985 using a Mocon Oxtran OTR testing system at an oxygen content of 100%, a relative humidity of 90%, and a temperature of 23° C.

“Melt Strength” is measured according to the following procedure. Melt strength measurements are conducted on a Göttfert Rheotens 71.97 (Göttfert Inc.; Rock Hill, S.C.) attached to a Göttfert Rheotester 2000 capillary rheometer. The polymer melt is extruded through a capillary die with a flat entrance angle (180 degrees), with a capillary diameter of 2.0 mm, and an aspect ratio (capillary length/capillary diameter) of 15. After equilibrating the samples at 190° C. for 10 minutes, the piston is run at a constant piston speed of 0.265 mm/second. The standard test temperature is 190° C. The sample is drawn uniaxially to a set of accelerating nips, located 100 mm below the die, with an acceleration of 2.4 mm/sec2. The tensile force is recorded as a function of the take-up speed of the nip rolls. Melt strength is reported, as the plateau force (cN), before the strand breaks. The following conditions are used in the melt strength measurements: plunger speed=0.265 mm/sec; wheel acceleration=2.4 mm/sec2; capillary diameter=2.0 mm; capillary length=30 mm; and barrel diameter=12 mm.

Additional properties and test methods are described further herein.

In one aspect, the present invention provides a polymer blend that comprises a polyethylene, nanocellulose, wherein the nanocellulose comprises 0.5 to 5 weight percent of the blend based on the total weight of the blend, and maleic anhydride-grafted polyethylene, wherein the maleic anhydride-grafted polyethylene comprises 0.5 to 5 weight percent of the blend based on the total weight of the blend.

In some embodiments, the nanocellulose is at least partially coated with lignin.

In some embodiments, the polymer blend comprises 0.5 to 2.5 weight percent nanocellulose based on the total weight of the blend. Polymer blends of the present invention, in some embodiments, comprise 0.5 to 2.5 weight percent maleic anhydride-grafted polyethylene based on the total weight of the blend. In some embodiments of the present invention, the ratio of the weight percentage of nanocellulose in the blend to the weight percentage of maleic anhydride-grafted polyethylene in the blend is between 0.8:1 and 1.2:1.

Films formed from polymer blends of the present invention can exhibit one or more desirable properties. In some embodiments, a film formed from a polymer blend of the present invention exhibits a water vapor transmission rate at least 10% lower than the water vapor transmission rate of a film formed from a polymer blend that differs from the polymer blend only in the absence of nanocellulose, when measured according to ASTM F-1249. A film formed from a polymer blend, in some embodiments, exhibits a Young's elastic modulus at least 10% greater than the Young's elastic modulus of a film formed from a polymer blend that differs from the polymer blend only in the absence of nanocellulose, when measured according to ASTM D-1708. In some embodiments, a polymer blend of the present invention exhibits a melt strength at least 15% greater than the melt strength of a polymer blend that differs from the polymer blend of the present invention only in the absence of nanocellulose.

In some embodiments, the polymer blend further comprises at least one of an oxidant, a colorant, a slip agent, an antiblock, a processing aid, or a combination thereof.

The polymer blend can comprise a combination of two or more embodiments as described herein.

Embodiments of the present invention also relate to monolayer films formed from a polymer blend of the present invention. Monolayer films of the present invention can comprise a combination of two or more embodiments as described herein.

Embodiments of the present invention also relate to multilayer films that include a layer formed from a polymer blend of the present invention. Multilayer films of the present invention can comprise a combination of two or more embodiments as described herein.

Embodiments of the present invention also relate to articles comprising any of the monolayer films or multilayer films disclosed herein. In some embodiments, the article is a package such as a food package.

Polymer blends of the present invention comprise nanocellulose. Nanocellulose generally refers to nano-structured cellulose and is understood to include nanocrystalline cellulose (NCC), cellulose nanofibers (CNF), and microfibrillated cellulose (MFC). A variety of types of nanocellulose can be used in embodiments of the present invention. In some embodiments, the nanocellulose comprises nanocrystalline cellulose. In some embodiments, the nanocellulose comprises cellulose nanofibers. In some embodiments, the nanocellulose is hydrophobic. While nanocellulose is generally hydrophilic, in some embodiments, the nanocellulose can be modified to make it more hydrophobic using techniques such as chemical treatment. For example, in some embodiments, the nanocellulose can at least be partially coated with lignin to make it more hydrophobic. Examples of nanocellulose that can be used in embodiments of the invention include BioPlus-L nanocrystalline cellulose which is commercially available from American Process, Inc., as well as microfibrillated cellulose commercially available from FiberLean Technologies, microfibrillated cellulose commercially available from Borregaard, and nanocrystalline cellulose and microfibrillated cellulose commercially available from Cellulose Lab.

In some embodiments of the present invention where the nanocellulose comprises nanocrystalline cellulose, the average particle size of the nanocrystalline cellulose is 4-5 nanometers wide and 50-500 nanometers in length.

In some embodiments, the nanocellulose is at least partially coated with lignin. In such embodiments, the nanocellulose can have a lignin content of 3-6%.

The amount of nanocellulose that can be used in polymer blends of the present invention depends on a number of factors including, for example, the desired properties of the polymer blend, the desired properties of any films to be made from the polymer blend, the desired properties of articles to be made from such films or polymer blends, the ability of the nanocellulose to disperse in the polyethylene, and/or other factors. In some embodiments, the polymer blend comprises 0.5 to 5 weight percent nanocellulose based on the total weight of the blend. The polymer blend, in some embodiments, comprises 0.5 to 2.5 weight percent nanocellulose based on the total weight of the blend.

In addition to nanocellulose, polymer blends of the present invention further comprise polyethylene. A wide variety of polyethylenes can be used depending on a number of factors including, for example, the desired properties of the polymer blend, the desired properties of films to be made from the polymer blend, the desired properties of articles to be made from such films, the ability of the nanocellulose to disperse in the polyethylene, and/or other factors. A blend of polyethylenes can be used in some embodiments.

In some embodiments, the polyethylene has a density of 0.870 g/cm³ or more. All individual values and subranges from equal to or greater than 0.870 g/cm³ are included and disclosed herein; for example the density of the polyethylene can be equal to or greater than 0.870 g/cm³, or in the alternative, equal to or greater than 0.900 g/cm³, or in the alternative, equal to or greater than 0.910 g/cm³, or in the alternative, equal to or greater than 0.915 g/cm³, or in the alternative, equal to or greater than 0.920 g/cm³. The polyethylene has a density equal or less than 0.970 g/cm³. All individual values and subranges from equal to or less than 0.970 g/cm³ are included and disclosed herein. For example, the density of the polyethylene can be equal to or less than 0.970 g/cm³, or in the alternative, equal to or less than 0.960 g/cm³, or in the alternative, equal to or less than 0.955 g/cm³, or in the alternative, equal to or less than 0.950 g/cm³.

In some embodiments, the polyethylene has a melt index (I₂) of 20 g/10 minutes or less. All individual values and subranges up to 20 g/10 minutes are included herein and disclosed herein. For example, the polyethylene can have a melt index from a lower limit of 0.2, 0.25, 0.5, 0.75, 1, 2, 4, 5, 10 or 15 g/10 minutes to an upper limit of 1, 2, 4, 5, 10, or 15 g/10 minutes. The polyethylene has a melt index (I₂) of up to 15 g/10 minutes in some embodiments. The polyethylene has a melt index (I₂) of up to 10 g/10 minutes in some embodiments. In some embodiments, the polyethylene has a melt index (I₂) less than 5 g/10 minutes.

Polyethylenes that are particularly well-suited for use in some embodiments of the present invention include linear low density polyethylene (LLDPE), low density polyethylene (LDPE), high density polyethylene (HDPE), enhanced polyethylene (EPE), and combinations thereof.

Various commercially available polyethylenes are contemplated for use in polymer blends of the present invention. Examples of commercially available LDPE that can be used in embodiments of the present invention include those available from The Dow Chemical Company under the names DOW LDPE™ and AGILITY™. Examples of commercially available LLDPE that can be used in embodiments of the present invention include DOWLEX™ linear low density polyethylene commercially available from The Dow Chemical Company, such as DOWLEX™ 2038.68G. Examples of commercially available HDPE that can be used in embodiments of the present invention include those available from The Dow Chemical Company under the names DOW™ HDPE resins and DOWLEX™. In addition to HDPE resins, the polyolefin used in the polymer blend can also include enhanced polyethylenes. Examples of commercially available enhanced polyethylene resins that can be used in embodiments of the present invention include ELITE™, ELITE™ AT, and AFFINITY™ enhanced polyethylenes, such as ELITE™ 5400G, which are commercially available from The Dow Chemical Company. Examples of other polyethylene resins that can be used in some embodiments of the present invention are INNATE™ polyethylene resins available from The Dow Chemical Company. Persons of skill in the art can select other suitable commercially available polyethylenes for use in polymer blends based on the teachings herein.

The polymer blend comprises up to 99 weight percent polyethylene based on the weight of the blend in some embodiments. In some embodiments, the polymer blend comprises 50 weight percent or more polyethylene based on the weight of the blend in some embodiments. In some embodiments, the polymer blend comprises 60 weight percent or more polyethylene based on the weight of the blend. In some embodiments, the polymer blend can comprise 50 to 99 wt % polyethylene based on the weight of the blend. All individual values and subranges from 0 to 99 wt % are included and disclosed herein; for example, the amount of polyethylene in the polymer blend can be from a lower limit of 50, 55, 60, 65, 70, 75, 80, or 85 wt % to an upper limit of 55, 60, 65, 70, 75, 80, 85, 90, 95, 96, 97, 98, or 99 wt %. For example, the amount of polyethylene in the polymer blend can be from 60 to 99 wt %, or in the alternative, from 70 to 99 wt %, or in the alternative, from 80 to 99 wt %, or in the alternative, from 85 to 99 wt %, or in the alternative, from 90 to 99 wt %.

Polymer blends of the present invention further comprise a maleic anhydride grafted polyethylene (MAH-g-PE). The MAH-g-PE is believed to further enhance compatibility of the nanocellulose within the polyethylene matrix. The grafted polyethylene may be any number of polyethylenes including, for example, ultralow density polyethylene (ULDPE), low density polyethylene (LDPE), linear low density polyethylene (LLDPE), medium density polyethylene (MDPE), high density polyethylene (HDPE), high melt strength high density polyethylene (HMS-HDPE), ultrahigh density polyethylene (UHDPE), and combinations thereof. In some embodiments, the grafted polyethylene comprises linear low density polyethylene, low density polyethylene, or high density polyethylene. The amount of maleic anhydride constituent grafted onto the polyethylene chain is greater than 0.05 weight percent to 3 weight percent (based on the weight of the olefin interpolymer), as determined by titration analysis, FTIR analysis, or any other appropriate method. More preferably, this amount is 0.6 to 2.7 weight percent based on the weight of the olefin interpolymer. In some embodiments, the amount of maleic anhydride grafted constituents is 1.0 to 2.0 weight percent based on the weight of the olefin interpolymer. The amount of maleic anhydride grafted constituents is 1.0 to 1.6 weight percent, in some embodiments, based on the weight of the olefin interpolymer.

In some embodiments, the MAH-g-PE has a melt index (I₂) of 0.2 g/10 minutes to 15 g/10 minutes. All individual values and subranges between 0.2 and 15 g/10 minutes are included herein and disclosed herein. For example, the MAH-g-PE can have a melt index from a lower limit of 0.2, 1, 2, 3, 4, 5, 6, 7, 8, 9, 10, or 11 g/10 minutes to an upper limit of 5, 6, 7, 8, 9, 10, 11, 12, 13, 14, or 15 g/10 minutes. The MAH-g-PE has a melt index (I₂) of 1 to 10 g/15 minutes in some embodiments. The MAH-g-PE has a melt index (I₂) of 1 to 10 g/10 minutes in some embodiments. In some embodiments, the MAH-g-PE has a melt index (I₂) of 1 to 5 g/10 minutes.

The graft process for MAH-g-PE can be initiated by decomposing initiators to form free radicals, including azo-containing compounds, carboxylic peroxyacids and peroxyesters, alkyl hydroperoxides, and dialkyl and diacyl peroxides, among others. Many of these compounds and their properties have been described (Reference: J. Branderup, E. Immergut, E. Grulke, eds. “Polymer Handbook,” 4th ed., Wiley, New York, 1999, Section II, pp. 1-76.). It is preferable for the species that is formed by the decomposition of the initiator to be an oxygen-based free radical. It is more preferable for the initiator to be selected from carboxylic peroxyesters, peroxyketals, dialkyl peroxides, and diacyl peroxides. Some of the more preferable initiators, commonly used to modify the structure of polymers, are listed in U.S. Pat. No. 7,897,689, in the table spanning Col. 48 line 13-Col. 49 line 29, which is hereby incorporated by reference. Alternatively, the grafting process for MAH-g-PE can be initiated by free radicals generated by thermal oxidative process.

Optionally, MAH-g-PE can be replaced or combined with a variety of grafted polyolefins that comprising radically graftable species. These species include unsaturated molecules, each containing at least one heteroatom. These species include, but are not limited to, maleic anhydride, dibutyl maleate, dicyclohexyl maleate, diisobutyl maleate, dioctadecyl maleate, N-phenylmaleimide, citraconic anhydride, tetrahydrophthalic anhydride, bromomaleic anhydride, chloromaleic anhydride, nadic anhydride, methylnadic anhydride, alkenylsuccinic anhydride, maleic acid, fumaric acid, diethyl fumarate, itaconic acid, citraconic acid, crotonic acid, and the respective esters, imides, salts, and Diels-Alder adducts of these compounds.

Examples of MAH-g-PE that can be used in polymer blends of the present invention include those commercially available from The Dow Chemical Company under the trade name AMPLIFY™ such as AMPLIFY™ GR 205.

The amount of MAH-g-PE that can be used in polymer blends of the present invention depends on a number of factors including, for example, the amount of nanocellulose used in the polymer blend, the desired properties of the polymer blend, the desired properties of any films to be made from the polymer blend, the desired properties of articles to be made from such films or polymer blends, the ability of the nanocellulose to disperse in the polyethylene, and/or other factors. In some embodiments, the polymer blend comprises 0.5 to 5 weight percent MAH-g-PE based on the total weight of the blend. The polymer blend, in some embodiments, comprises 0.5 to 2.5 weight percent MAH-g-PE cellulose based on the total weight of the blend.

The amount of nanocellulose relative to MAH-g-PE can be important in some embodiments. In some embodiments, the ratio of the weight percentage of nanocellulose in the blend to the weight percentage of MAH-g-PE in the blend is between 0.8:1 and 1.2:1, based on the total weight of the blend. The ratio of the weight percentage of nanocellulose in the blend to the weight percentage of MAH-g-PE in the blend is between 0.9:1 and 1.1:1, based on the total weight of the blend in some embodiments. In some embodiments, a polymer blend comprises approximately the same amount of nanocellulose and MAH-g-PE on a weight percentage basis, based on the total weight of the blend.

In some embodiments, the polymer blend can further comprise one or more additives known to those of skill in the art including, for example, antioxidants, colorants, slip agents, antiblocks, processing aids, and combinations thereof. In some embodiments, the polymer blend comprises up to 5 weight percent of such additives. All individual values and subranges from 0 to 5 wt % are included and disclosed herein; for example, the total amount of additives in the polymer blend can be from a lower limit of 0.5, 1, 1.5, 2, 2.5, 3, 3.5, 4, or 4.5 wt % to an upper limit of 1, 2, 3, 4, or 5 wt %.

In some embodiments, a polymer blend of the present invention exhibits a melt strength at least 15% greater than the melt strength of a polymer blend that differs from the polymer blend only in the absence of nanocellulose. In some embodiments, a polymer blend of the present invention exhibits a melt strength at least 25% greater than the melt strength of a polymer blend that differs from the polymer blend of the present invention only in the absence of nanocellulose. A polymer blend, in some embodiments, of the present invention exhibits a melt strength at least 30% greater than the melt strength of a polymer blend that differs from the polymer blend of the present invention only in the absence of nanocellulose. In some embodiments, a polymer blend of the present invention exhibits a melt strength up to 50% greater than the melt strength of a polymer blend that differs from the polymer blend of the present invention only in the absence of nanocellulose.

As will be discussed below, a polymer blend of the present invention can be incorporated/converted into a film (e.g., a blown film, a cast film, etc.).

Polymer blends of the present invention can be prepared by melt blending the prescribed amounts of the components with a twin screw extruder before feeding into an extruder or other equipment used for film fabrication. Such polymer blends can also be prepared by tumble blending the prescribed amounts of the components before feeding into the extruder or other equipment used for film fabrication. In some embodiments, polymer blends of the present invention can be in the form of pellets. For example, the individual components can be melt blended and then formed into pellets using a twin screw extruder or other techniques known to those of skill in the art based on the teachings herein.

Polymer blends of the present invention can be used to make a number of products including, for example, monolayer films and multilayer films. Thus, some embodiments of the present invention relate to monolayer films comprising any of the polymer blends of the present invention. Some embodiments of the present invention relate to multilayer films comprising any of the polymer blends of the present invention. Such monolayer films and multilayer films may generally be produced using techniques known to those of skill in the art based on the teachings herein.

In some embodiments, a film formed from a polymer blend of the present invention exhibits a water vapor transmission rate at least 10% lower than the water vapor transmission rate of a film formed from a polymer blend that differs from the polymer blend only in the absence of nanocrystalline cellulose and maleic-anhydride grafted polyethylene, when measured according to ASTM F-1249. A film formed from a polymer blend of the present invention, in some embodiments, exhibits a water vapor transmission rate at least 25% lower than the water vapor transmission rate of a film formed from a polymer blend that differs from the polymer blend only in the absence of nanocrystalline cellulose and maleic-anhydride grafted polyethylene, when measured according to ASTM F-1249.

In some embodiments, a film formed from a polymer blend of the present invention exhibits a Young's elastic modulus at least 10% greater than the Young's elastic modulus of a film formed from a polymer blend that differs from the polymer blend only in the absence of nanocrystalline cellulose and maleic-anhydride grafted polyethylene, when measured according to ASTM D-1708.

Monolayer or multilayer films of the present invention, in some embodiments, may exhibit one or more such physical properties, as well other physical properties.

Embodiments of the present invention also provide packages formed from any of the films described herein. Examples of such packages can include flexible packages, pouches, stand-up pouches, and pre-made packages or pouches. Such packages can be formed using techniques known to those of skill in the art in view of the teachings herein.

Some embodiments of the invention will now be described in detail in the following Examples.

### EXAMPLES

The following materials are used in the examples discussed below:

| | | Melt Index (I₂) | Density |
|---|---|---|---|
| Product | Abbreviation | (dg/min) | (g/cm³) |
| DOWLEX ™ 2038.68G | D2038 | 1.0 | 0.935 |
| AMPLIFY ™ GR205 | GR205 | 2.0 | 0.960 |
| BIOPLUS-L Crystals | CNC | 1.50 | — |

DOWLEX™ 2038.68G is a LLDPE commercially available from The Dow Chemical Company. AMPLIFY™ GR205 is a maleic anhydride grafted HDPE commercially available from The Dow Chemical Company. BIOPLUS-L Crystals are lignin-coated cellulose nanocrystals available from American Process Inc. According to the technical data sheet from American Process Inc., BIOPLUS-L Crystals are hydrophobic having an average particle width of 4-5 nm, an average particle width of 50-500 nm, a cellulose crystallinity (XRD) of 93%, a density of 1.05 g/cm³ (aqueous gel) or 1.50 g/cm³ (dry powder), and a lignin content of ˜3-6 weight percent.

Several samples are melt-compounded as specified in Table 1:

TABLE 1

| | Composition, Wt. % | | |
|---|---|---|---|
| | D2038G | CNC | GR205 |
| Comparative Example A | 100.0 | 0.0 | 0.0 |
| Comparative Example B | 99.0 | 0.0 | 1.0 |
| Inventive Example 1 | 99.0 | 1.0 | 0.0 |
| Inventive Example 2 | 98.0 | 1.0 | 1.0 |

Inventive Examples 1 and 2 represent embodiments of polymer blends of the present invention. Each of the above blends are fabricated into films on a Collin co-extrusion blown film line (Model BL 180/400 from Dr. Collin GMBH) under the conditions shown in Table 2 to form a monolayer blown film (Layers A, B and C using the same material):

TABLE 2

| Parameter Name | Unit | Value |
|---|---|---|
| Layer ratio - Layer A | % | 30 |
| Layer ratio - Layer B | % | 40 |
| Layer ratio - Layer C | % | 30 |
| Total Thickness | μm | 55.8 |
| Air Temperature | ° C. | 15 |
| Layflat | mm | 314 |
| Blow Up Ratio (B.U.R.) | | 2.5 |
| Die gap | mm | 1.8 |
| Blower | % | 58 |
| Takeoff | m/min | 3.8 |
| Structure | | A/A/A |
| Total Output | kg/h | 20.32 |
| Die Temperature | ° C. | 210 |
| Temperature-Zone 02 - Extruder A (External) | ° C. | 190 |
| Temperature-Zone 03 - Extruder A (External) | ° C. | 205 |
| Temperature-Zone 04 - Extruder A (External) | ° C. | 210 |
| Temperature-Zone 05 - Extruder A (External) | ° C. | 210 |
| Temperature-Zone 06 - Extruder A (External) | ° C. | 210 |
| Temperature-Zone 07 - Extruder A (External) | ° C. | 210 |
| RPM - Extruder A (External) | rpm | 50 |
| Amps - Extruder A (External) | A | 5.6 |
| Melt temperature - Extruder A (External) | ° C. | 202 |
| Melt pressure - Extruder A (External) | bar | 289 |
| Output - Extruder A (External) | kg/h | 3.98 |
| Temperature-Zone 02 - Extruder B | ° C. | 190 |
| Temperature-Zone 03 - Extruder B | ° C. | 205 |
| Temperature-Zone 04 - Extruder B | ° C. | 210 |
| Temperature-Zone 05 - Extruder B | ° C. | 210 |
| Temperature-Zone 06 - Extruder B | ° C. | 210 |
| Temperature-Zone 07 - Extruder B | ° C. | 210 |
| RPM - Extruder B | rpm | 96 |
| Amps - Extruder B | A | 4.2 |
| Melt temperature - Extruder B | ° C. | 209 |
| Melt pressure - Extruder B | bar | 332 |
| Output - Extruder B | kg/h | 4.06 |
| Temperature-Zone 02 - Extruder C | ° C. | 190 |
| Temperature-Zone 03 - Extruder C | ° C. | 205 |
| Temperature-Zone 04 - Extruder C | ° C. | 210 |
| Temperature-Zone 05 - Extruder C | ° C. | 210 |
| Temperature-Zone 06 - Extruder C | ° C. | 210 |
| Temperature-Zone 07 - Extruder C | ° C. | 210 |
| RPM - Extruder C | rpm | 96 |
| Amps - Extruder C | A | 3.9 |
| Melt temperature - Extruder C | ° C. | 215 |
| Melt pressure - Extruder C | bar | 304 |
| Output - Extruder C | kg/h | 4.22 |

The average secant modulus (1% and 2%) is measured for each of the films in accordance with ASTM D882, and the results are shown in Table 3:

TABLE 3

| | Avg. Secant | | Avg. Secant | |
|---|---|---|---|---|
| | Modulus - Cross | | Modulus - Machine | |
| | Direction (Psi) | | Direction (Psi) | |
| Sample Description | Avg@1% | Avg@2% | Avg@1% | Avg@2% |
| Comparative Example A | 63563 | 51564 | 54234 | 45146 |
| Comparative Example B | 64256 | 51172 | 53632 | 43975 |
| Inventive Example 1 | 88210 | 71023 | 76493 | 62022 |
| Inventive Example 2 | 82663 | 66610 | 68637 | 57602 |

As shown above, the stiffness of the monolayer films increases with the presence of 1% nanocellulose and with the combination of 1% nanocellulose and 1% maleic anhydride-grafted polyethylene. In particular, the data show that adding 1% nanocellulose in the film (Inventive Examples 1 and 2) increases the stiffness (in both the CD and the MD) by more than 20%. Higher film stiffness, as characterized by higher modulus, offers the potential to downgauge both monolayer and multilayer films and thus reduce cost.

The water vapor transmission rates (WVTR) of the films are measured in accordance with ASTM F-1249 using a Mocon Permatran WVTR testing system (Model 3/33) at a relative humidity of 100% and a temperature of 37.8° C. The oxygen transmission rates (OTR) are measured in accordance with ASTM D3985 using a Mocon Oxtran OTR testing system (Model 2/21) at an oxygen content of 100%, a relative humidity of 90%, and a temperature of 23° C. These properties are measured on a six inch by six inch sample of the films. At least three measurements of each example film are made and the average values are shown in Table 4:

TABLE 4

| | WVTR | OTR |
|---|---|---|
| | (g*mil/(100 | (cc*mil/(100 |
| | inch\hat{ }2*day)) | inch\hat{ }2*day)) |
| Comparative Example A | 0.43 | 266.4 |
| Comparative Example B | 0.41 | 246.1 |
| Inventive Example 1 | 0.39 | 259.6 |
| Inventive Example 2 | 0.36 | 257.6 |

The data in Table 4 show an improvement in WVTR when 1 weight percent of nanocellulose and maleic anhydride-grafted polyethylene are used in the film structure (Inventive Example 2). The improvement is roughly 16% over Comparative Example A. For context, the standard deviation for this measurement method is less than 2%. Also, an improvement of 3% is observed for Inventive Example 2 relative to Comparative Example A.

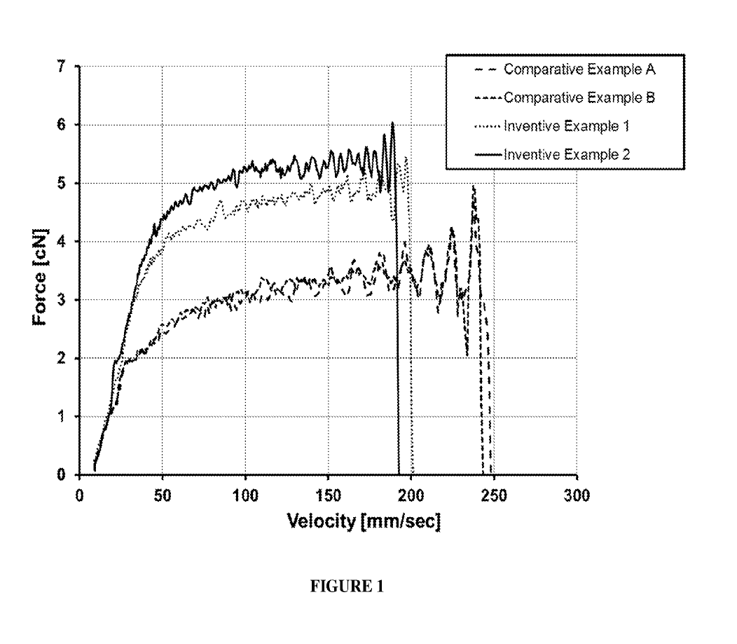

The melt strengths of the polymer blends are also measured as described above. The results are shown in FIG. 1. FIG. 1 shows that when 1 weight percent of nanocellulose and 1 weight percent of maleic anhydride-grafted polyethylene are used in the film structure (Inventive Example 2), more than 40% improvement can be obtained on the melt strength rheological data. Melt strength is an important property for bubble stability during the blown film process. Melt strength is also an important property for other applications such as extrusion coating where it can help minimize neck-in.

The optical properties of the films are also measured. Clarity is determined in accordance with ASTM D1746. Gloss @45° is determined in accordance with ASTM D2457. Haze is determined in accordance with ASTM D1003. The data in Table 5 show that the presence of 1 wt. % of maleic anhydride-grafted polyethylene assists with the dispersion of the nanocellulose within the polyethylene matrix (Inventive Example 2), thus improving most optical properties to levels similar to the control sample (Comparative Example A).

TABLE 5

| | | | Total | Internal |
|---|---|---|---|---|
| | Clarity | Gloss @45° | Haze | Haze |
| | (%) | (%) | (%) | (%) |
| Comparative Example A | 99.06 | 63.28 | 11.48 | 6.21 |
| Comparative Example B | 99.28 | 70.7 | 7.65 | 3.73 |
| Inventive Example 1 | 79.14 | 45.04 | 20.72 | 10.61 |
| Inventive Example 2 | 83.84 | 60.08 | 12.88 | 6.94 |

1. A polymer blend comprising:
a polyethylene;
nanocellulose, wherein the nanocellulose comprises 0.5 to 5 weight percent of the blend based on the total weight of the blend; and
maleic anhydride-grafted polyethylene, wherein the maleic anhydride-grafted polyethylene comprises 0.5 to 5 weight percent of the blend based on the total weight of the blend.

2. The polymer blend of claim 1, wherein the nanocellulose comprises nanocrystalline cellulose.

3. The polymer blend of claim 1, wherein the nanocellulose is at least partially coated with lignin.

4. The polymer blend of claim 1, wherein the polymer blend comprises 0.5 to 2.5 weight percent nanocellulose based on the total weight of the blend.

5. The polymer blend of claim 1, wherein the polymer blend comprises 0.5 to 2.5 weight percent maleic anhydride-grafted polyethylene based on the total weight of the blend.

6. The polymer blend of claim 1 wherein the ratio of the weight percentage of nanocellulose in the blend to the weight percentage of maleic anhydride-grafted polyethylene in the blend is between 0.8:1 and 1.2:1.

7. The polymer blend of claim 1, wherein a film formed from the polymer blend exhibits a water vapor transmission rate at least 10% lower than the water vapor transmission rate of a film formed from a polymer blend that differs from the polymer blend only in the absence of nanocellulose, when measured according to ASTM F-1249.

8. The polymer blend of claim 1, wherein a film formed from the polymer blend exhibits a Young's elastic modulus at least 10% greater than the Young's elastic modulus of a film formed from a polymer blend that differs from the polymer blend only in the absence of nanocellulose, when measured according to ASTM D-1708.

9. The polymer blend of claim 1, wherein the blend exhibits a melt strength at least 15% greater than the melt strength of a polymer blend that differs from the polymer blend only in the absence of nanocellulose.

10. A monolayer film comprising the polymer blend of claim 1.

11. A multilayer film, wherein at least one layer comprises the polymer blend of claim 1.

12. A package comprising the multilayer film of claim 10.
